(19) United States
(12) Patent Application Publication
(10) Pub. No.: US 2019/0238053 A1
(43) Pub. Date: Aug. 1, 2019

(54) Multi-Source Power Supply Having a Self-Impedance Matching Energy Harvester with Clamped Output Voltage

(71) Applicant: The Charles Stark Draper Laboratory, Inc., Cambridge, MA (US)

(72) Inventors: Alexander OLIVA, Addison, IL (US); Elliot H. GREENWALD, Cambridge, MA (US)

(73) Assignee: The Charles Stark Draper Laboratory, Inc., Cambridge, MA (US)

(21) Appl. No.: 16/231,897

(22) Filed: Dec. 24, 2018

Related U.S. Application Data
(60) Provisional application No. 62/609,821, filed on Dec. 22, 2017.

(51) Int. Cl. H02M 3/07; H02J 50/20; G05F 1/46; H02M 7/12

(52) U.S. Cl. CPC H02M 3/073; H02M 7/12; G05F 1/46; H02J 50/20

(57) ABSTRACT

A multi-source power supply includes at least two power supply paths, both of which supply currents to a load. One of the power supply paths includes a voltage regulator configured to produce a first output voltage. The other power supply path constitutes an RF energy harvester which includes an RF antenna, a rectifier and a charge pump. The output voltage of the charge pump is clamped by the first output voltage from the voltage regulator of the first power path. Due to the clamped output voltage of the charge pump, the RF energy harvester undergoes self-impedance matching between the rectifier output and charge pump input.

### RELATED APPLICATIONS

This application claims priority from and the benefit of U.S. Provisional Patent Application No. 62/609,821, filed Dec. 22, 2017, the entire contents of which are incorporated herein by reference.

### STATEMENT OF GOVERNMENT INTEREST

None.

### TECHNICAL FIELD

The present disclosure relates generally to circuits for harvesting energy from an RF signal. More particularly, it is directed to circuits that augment RF-harvested energy with an additional power source to meet the current and voltage requirements of a known load.

### BACKGROUND

The prior art includes circuitry that relies solely on harvested RF energy to power a system (as a primary harvester). However, this only works for incredibly low power systems. RF energy harvesters are very inefficient and thus incapable of harvesting large amounts of energy for a given received power. Impedance-matching networks comprising discrete inductors and capacitors are often used to improve antenna matching, adding weight and area.

Certain prior art energy harvesters work at relatively low frequencies, on the order of 100's of Hz rather than RF. Such energy harvesters have used switched-capacitor charge pumps to impedance-match to an antenna connected to a rectifier. However, actively-switched charge pump have high gate losses while diode-rectifiers are very inefficient due to the diode voltage drops. Results with high efficiencies only operated to low frequencies (100's of Hz) such that the circuitry could follow the changing sine wave and not need a rectifier (the largest source of losses). Other attempts have used charge pumps to charge up an energy store element (e.g. battery or supercapacitor).

### SUMMARY

The subject matter of the present application is directed to an energy circuit combining an RF harvester with a voltage regulator to create an auxiliary energy harvester. The energy harvesting system therefore allows the small amount of harvested energy from the RF harvester to couple with a higher power source (e.g. a battery or a higher power energy harvester). By using a fully integrated charge pump as the RF harvester on a locked output from the voltage regulator, the input impedance of the charge pump is very accurately predicted and a controller is designed such that an impedance-matching network is not needed. The subject matter of the present application therefore addresses the problem of low harvester energy, and high weight from a discrete matching network.

The energy circuit uses a locked output voltage created by the voltage regulator to accurately predict the input impedance of the charge pump in order to impedance-match to the antenna-rectifier (“rectenna”). This allows the RF harvester to function as an auxiliary harvester that works in tandem with a higher power source (e.g., a battery, a primary harvester, etc.). It allows low harvested RF energy to still apply to high-power loads and in doing so extends battery life or increases the maximum power that a load can draw, since the load has both a primary energy source and an auxiliary energy source from which to draw current.

The charge pump is impedance-matched by changing the number of enabled stages within the charge pump. Rather than using an actively-switched charge pump which has high gate losses, by replacing the charge pump with a string of diode-based voltage doublers (similar to the actual rectifier) and using active switches to change the number of doublers used, the circuit's quiescent current could be greatly reduced. However, diode-rectifiers are very inefficient due to the diode voltage drops, thus favoring a charge pump having low quiescent current, which would typically require a simple, low-power controller.

The subject matter of the present application thus discloses a structural combination in which a locked output voltage facilitates impedance-matching allowing a simple controller to perform impedance-matching by changing the charge pump's internal number of operating stages, thereby creating an auxiliary harvester.

In one aspect, the subject matter of the present application is directed to a multi-source power supply comprising: a primary power source; a voltage regulator configured to receive power from the primary power source and, in response thereto, output a predetermined constant DC voltage Vo at a regulator voltage output; an auxiliary DC power source having an auxiliary direct current (DC) voltage output Vrec; and a charge pump having the auxiliary DC voltage output Vrec input thereto, and further having a charge pump output; wherein: the regulator voltage output is connected to the charge pump output such that the charge pump output is clamped at said predetermined constant DC voltage Vo output by the voltage regulator.

The multi-source power support may further comprise a controller configured to control operation of the charge pump; wherein the charge pump is operable in a plurality of operational states and an output current of the charge pump is a function of the specific state in which the charge pump operates; and the controller is configured to determine in which state the charge pump operates, in response to the auxiliary DC voltage output Vrec and without reference to the output voltage of the charge pump.

The charge pump may comprise a plurality of stages; an operational state of the charge pump is determined by the number of stages that are enabled; and the controller is configured to determine which stages to enable, in response to the auxiliary DC voltage output (Vrec).

The charge pump may be a switched-capacitor charge pump comprising a plurality of switches configured to control current flow through a plurality of capacitors; and the controller may comprise a lookup table storing information reflective of which switches are to be open and which switches are to be closed, the lookup table being indexed in response to a value of the auxiliary DC voltage output (Vrec).

Each stage of the charge pump may comprise a single capacitor and a plurality of switches which are configured to control transfer of charge to said single capacitor.

In any given operational state, the charge pump cycles between two complementary phases; and the controller comprises logic configured to determine when to cycle the charge pump between the two complementary phases.

The output voltage of the charge pump may not be provided to the controller at all.

The controller may be configured to control the charge pump such that an input impedance of the charge pump is maintained to match a source impedance of the auxiliary DC power source, in each operational state.

### BRIEF DESCRIPTION OF THE DRAWINGS

FIG. 1 shows a block diagram of a multi-source power supply which includes a primary harvester having a 2.0-V low-dropout regulator (LDO), and an auxiliary RF harvester which includes a rectifier-to-charge pump path, with the LDO configured to fix the output voltage.

FIG. 2 shows a schematic of an RF rectifier of the sort used in the circuit of FIG. 1.

FIG. 3 shows a Thevein equivalent of rectifier plus antenna (rectenna 148) (VTH and RTH) and a model of the charge pump 146 (Rin and Io) interfaced to a locked output voltage (Vo).

FIG. 4 shows a schematic of a Fibonacci charge pump operable in a plurality of operating states, and having a having a configurable number (between 1 and 6) enabled stages.

FIGS. 5A-5F show input resistance, charge pump efficiency, input current and power, and output current and power for one through six stages of the Fibonacci charge pump of FIG. 4 at a given capacitance-frequency (Cf) product.

FIG. 6 shows a Current-Voltage (IV) function of the charge pump input resistance 602 plotted against the IV function of the Thevenin equivalent of the rectenna 604.

FIG. 7 shows a comparator circuit used to quantize the rectifier output voltage; the combination of multiple such circuits with different thresholds encodes the number of enabled charge pump stages.

FIG. 8 shows a simulation of system controller controlling the charge pump.

FIG. 9 shows a functional diagram of the system controller's logic for operating the charge pump.

FIGS. 10A & 10B show switch positions for Phase 1 and Phase 2, respectively, for a charge pump having one active stage.

FIGS. 11A & 11B show switch positions for Phase 1 and Phase 2, respectively, for a charge pump having two active stages.

FIGS. 12A & 12B show switch positions for Phase 1 and Phase 2, respectively, for a charge pump having three active stages.

FIGS. 13A & 13B show switch positions for Phase 1 and Phase 2, respectively, for a charge pump having four active stages.

FIGS. 14A & 14B show switch positions for Phase 1 and Phase 2, respectively, for a charge pump having five active stages.

FIGS. 15A & 15B show switch positions for Phase 1 and Phase 2, respectively, for a charge pump having six active stages.

FIG. 16A shows a discrete circuit implementation of the rectifier, charge pump, and comparators, while FIG. 16B shows the interface between the 6 controller outputs and the FPGA signals used to control the 24 switches of FIG. 4.

### DETAILED DESCRIPTION OF THE EMBODIMENTS

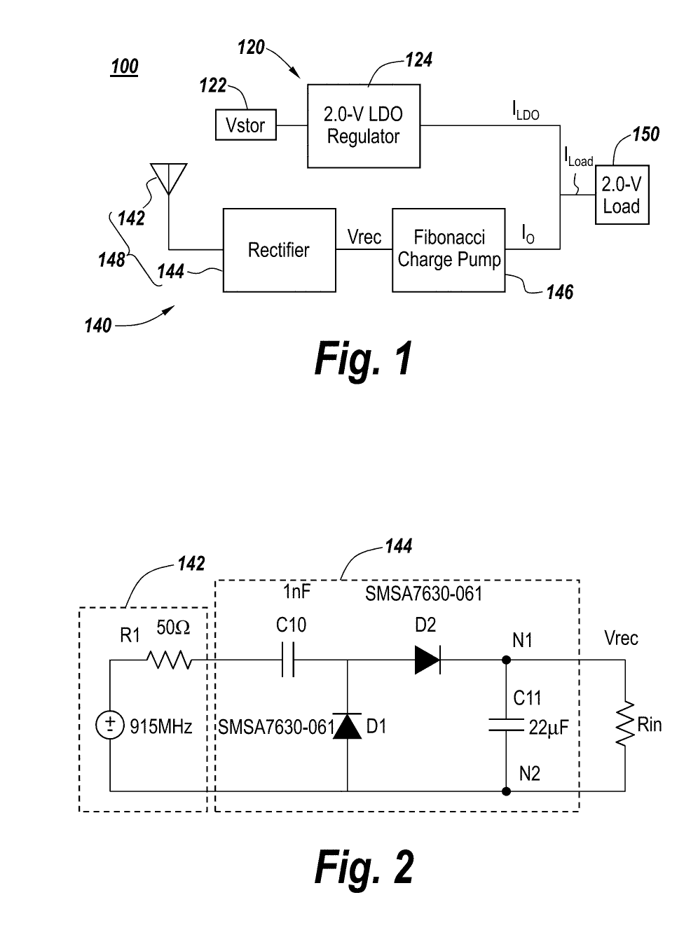

FIG. 1 depicts a block diagram of a multi-source power supply 100 in accordance with one embodiment of the subject matter of the present application. Multi-source power supply 100 is configured to supply a load current I_{Load} to a load 150, which in the exemplary embodiment is a 2.0 V load. The multi-source power supply 100 comprises a primary power circuit 120 configured to supply a first current I_{LDO} to the load 150 and an auxiliary (secondary) power circuit 140 configured to supply a second current I_{O} to the load, with I_{LDO}+I_{O}=I_{Load}. It is understood that the power circuits 120, 140 are connected in electrical parallel. It is also understood that while only one auxiliary power circuit 140 is shown, a plurality of auxiliary power circuits may be provided, each auxiliary power circuit connected in electrical parallel with the primary power circuit 120 and supply a portion of the load current I_{Load} to load 150.

In the embodiment shown, the primary power circuit 120 is implemented as a primary power source 122 configured to supply a DC voltage to a voltage regulator 124. The primary power source 122 may be implemented in one of several ways, and may comprise a DC battery, a solar or wind-powered energy supply, or the like. In this exemplary embodiment, the voltage regulator 124 comprises a low drop-out voltage regulator (LDO) 124, which is configured to output a constant output voltage Vo and in the embodiment shown is 2.0 V. In one embodiment, the Ricoh RP110N201B LDO regulator was chosen to implement the LDO 124.

The auxiliary power circuit 140 of FIG. 1 constitutes an RF energy harvester. In the embodiment shown, the RF energy harvester includes an antenna 142 and a rectifier 144 which together constitute a rectenna 148. The antenna 142 converts electromagnetic waves into voltage signals which are processed by the rectifier 144. In response to these voltage signals, the rectifier 144 outputs a rectified low voltage DC signal Vrec. The RF energy harvester of the auxiliary power circuit 140 also includes a charge pump 146, which receives the rectified low voltage DC signal Vrec, in response thereto, outputs a higher-voltage signal, as described further below.

While in the embodiment of FIG. 1, the RF energy harvester includes a rectenna 148 configured to process RF signals, other (non-RF) energy harvesters configured to produce low voltages may also be used. For instance, a piezoelectric generator or a thermoelectric generator may be used instead of an RF energy harvester. The principal requirement is that the energy harvester output a low voltage DC signal.

FIG. 2 illustrates an implementation of the rectifier 144 of FIG. 1. As seen in FIG. 2, the rectifier 144 can be in the form of a Cockcroft-Walton RF doubler, with a signal source and a source resistance R1 in the dashed box representing the antenna 142. As seen in this figure, the rectifier 144 is implemented using two RF diodes D1, D2 and two discrete capacitors C10, C11. The ideal unloaded output is then twice the input amplitude, with the output voltage Vrec appearing across capacitor C11 at rectifier nodes N1, N2. In exemplary embodiments, a 915 MHz RF electromagnetic signal was generated and subsequently processed by the rectenna. It is understood that RF signals in a wide range of frequencies could likewise be used, assuming proper antenna and rectifier circuitry were employed.

Using just the one rectifying stage of rectifier 144 seen in FIG. 2, will likely not produce usable voltages. The charge pump 146 is used to raise the low voltage DC signal Vrec to a more usable voltage. In a preferred embodiment the charge pump 146 is a switched capacitor (SC) charge pump which is used to multiply the rectifier output voltage Vrec to a usable level in the range of 0.5 V-5 V. One can choose from among a number of different switched capacitor circuits to serve as the charge pump 146. In the embodiment shown, the switched capacitor circuit operates as a Fibonacci multiplier, which has the highest voltage gain per capacitor.

As is known to those skilled in the art, switched capacitor voltage multipliers have an input resistance that depends on the output voltage. Therefore, impedance matching to SC multipliers can be very difficult. This issue is obviated if the output voltage of the SC charge pump can be pinned (“clamped”) to a known value.

In the multi-source power supply 100 embodiment of FIG. 1, the charge pump 146 outputs directly in parallel with the output of the LDO 124. If the power consumed by the load 150 is greater than the power output by the auxiliary power circuit 140 (i.e., from the rectenna/charge pump RF energy harvester), the LDO 124 will source some current via its output nodes (“regulator voltage output”). As a consequence, the LDO 124 will regulate the voltage across the load 150 and also will regulate the voltage at the charge pump's output nodes N5, N6 (“charge pump output”). Generally speaking, the output voltage of the LDO 124 is referenced to ground, and so one of the output nodes of the LDO and one of the output nodes (N5 or N6) of the charge pump 146 are ground nodes.

By carefully choosing capacitor and switching frequency values for the charge pump 146, and by designing a controller to turn on a variable number of charge pump stages, the Fibonacci switched capacitor multiplier 146 can be approximately impedance-matched to the rectenna over most input power values. This eliminates the need for discrete impedance matching inductors and capacitors, thus further decreasing the footprint of the auxiliary power circuit 140.

Thus, the multi-source power supply 100 seen in the embodiment of FIG. 1 has two power paths. The primary power circuit 120 forms a primary high-power path (“first power path”) from a battery or other high-power energy source (designated ‘Vstor’ in the figure). Meanwhile, the auxiliary power circuit 140 forms an auxiliary low-power path (“second power path”) from the antenna 142-rectifier 144-charge pump 146 combination, which collectively constitute an “RF harvester”. The LDO 124 is used from ‘Vstor’ so the output voltage is locked. The RF harvester then acts as a current source to provide current into the load 150. For the LDO 124 to provide a non-zero amount of current and provide a regulated output voltage, the current consumed by the load 150 must be greater than the current provided by the RF harvester. This is certainly the case with high-power loads but only a small amount of harvested RF energy. This makes the RF harvester an auxiliary harvester that solely cannot power the load but alleviates demands on the battery or primary harvester. The RF harvester relies on the regulated output from the LDO 124 in order to accurately predict the input impedance into the charge pump 146 and impedance-match to the rectenna without an impedance-matching network.

In FIG. 2 discussed above, the antenna 142 was modeled using signal source and source resistance R1, while the rectifier 144 was implemented as a Cockcroft-Walton RF doubler. To eliminate the need for a matching network, the rectifier impedance can be examined to directly impedance-match the effective output impedance of the rectifier to the effective input impedance Rin of the charge pump 146 to which the rectifier's output voltage Vrec is applied.

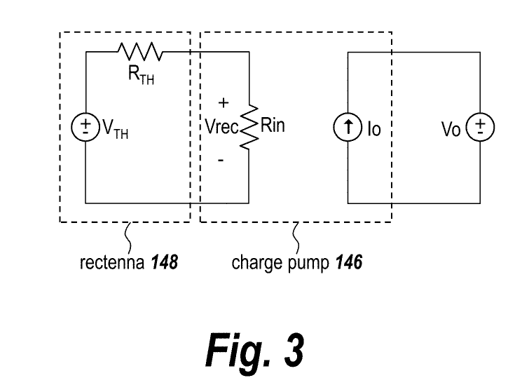

FIG. 3 shows the Thevenin equivalent model of rectenna 148 (antenna 142+ rectifier 14)) interfaced to a two-port model of the charge pump 146. The charge pump 146 is modeled with a variable input resistance Rin and a variable output current Io. Maximum power is extracted from the rectenna 148 when Rin is equal to Rth. The input impedance is given by:

$${R}_{in} = \frac{{F}_{k} {F}_{k + 1}}{{F}_{k + 2}^{2} Cf} \cdot \frac{{F}_{k + 2} {V}_{rec}}{{V}_{f + 2} {V}_{rec} - {V}_{o}}$$

where Fk is the kth element of the Fibonacci sequence, k is the number of switching capacitors, C is the capacitance of the switching capacitors that make up the charge pump 146, and f is the frequency at which the switches in the circuit are opened and closed. With the output voltage of the charge pump locked to Vo by the LDO 124 the expression for Rin is simplified. This allows a simple control algorithm to match Rin to Rth based on a quantized representation of Vrec.

Generally speaking, the charge pump 146 is operable in a plurality of operational states and the output current Io of the charge pump 146 is a function of the specific state in which the charge pump 146 operates. A controller determines the operational state of the charge pump 146 based, at least in part on the auxiliary DC voltage signal Vrec, but without reference to the output voltage of the charge pump 146 whose output nodes N5, N6 in any event are clamped to Vo by being connected to the corresponding output nodes of the LDO 124. In other words, since the regulator voltage output is connected to, and thereby clamps, the charge pump output, the output voltage at the charge pump output is not a factor. Indeed, the controller need not have the output voltage of the charge pump 146 input thereto at all.

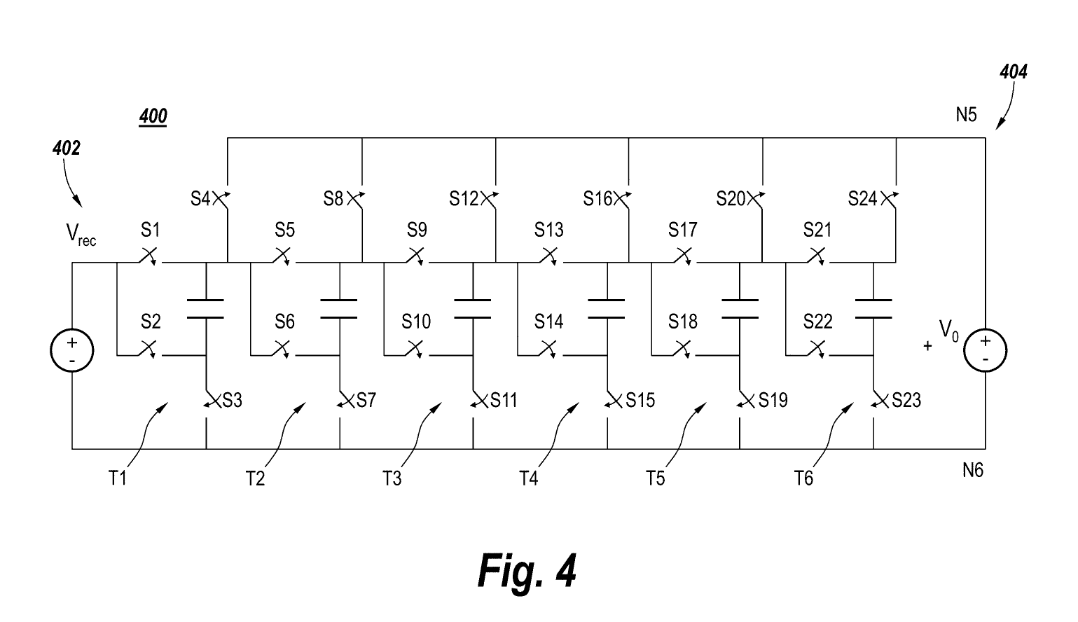

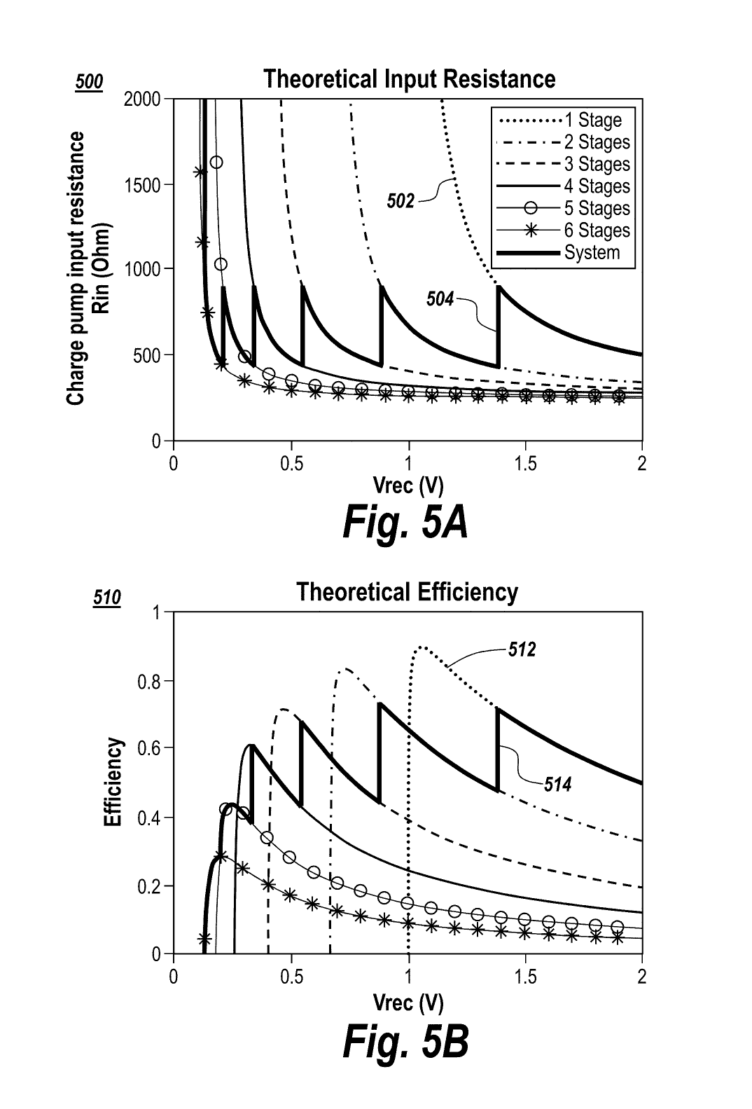

FIG. 4 shows a schematic representation of one embodiment 400 of the Fibonacci charge pump 124 whose output nodes N5, N6 are clamped to Vo (by being connected to the corresponding output nodes of the LDO 124). The charge pump 146 of FIG. 4 is seen to have a plurality of capacitors (preferably, though not necessarily, having the same capacitance) and a plurality of switches number S1, S2, . . . , etc. The charge pump 146 of FIG. 4 is shown to be organized into a plurality of stages arranged from the charge pump's input end 402 (where Vrec is schematically shown to be the input), to the output end 404 where the output nodes N5, N6 are shown. In this exemplary embodiment, a total of six stages are shown and they are indicated by T1, T2, T3, T4, T5 and T6. Each stage of the charge pump 146 comprises a capacitor and a plurality of switches which are configured to control transfer of charge to that capacitor.

The charge pump 146 follows the rectifier 144 to bring the rectified voltage to a usable value. In prior art rectifier-charge pump combinations, it is common to design the charge pump for a specified output resistance and voltage gain. This is because a very low output resistance decreases voltage drop for higher output currents. The present design locks the charge pump output to a fixed voltage Vo so that power from two multiple sources can be combined. This approach also simplifies the input resistance analysis.

As previously stated, there are many different switched capacitor charge pump topologies that can be used. The Fibonacci charge pump 146, depicted in FIG. 4, can achieve the highest voltage gain with the lowest number of capacitors, meaning it would consume the lowest area when integrated into an application specific integrated circuit (ASIC). Still, with a fixed output voltage, the input resistance can vary widely over the valid range of input antenna powers and therefore rectified voltages. Furthermore, the larger the difference between the input and output voltages, the less efficient the charge pump becomes. Using a variable number of stages addresses both problems; it keeps the input resistance within a certain range and the efficiency above a specific threshold.

Furthermore, the controller for such a solution is computationally simple, where the number of enabled stages depends only on the rectified voltage. Specifically, the rectified voltage can be sensed using a low-resolution analog-to-digital converter or series of comparators and can directly encode the number of enabled charge pump stages through a lookup table.

The charge pump 146 of FIG. 4 is configured to be operated such that each operational state of the charge pump 146 has a different number of stages from left-to-right enabled (active). Thus, in first operational state, only stage T1 is enabled; in a second operational state, stages T1 and T2 are enabled; in a third operational state, stages T1, T2 and T3 are enabled, etc. As described further below, the controller operates switches S1 through S24, depending on the value of the auxiliary DC voltage signal (Vrec), to switch between the various operational states. Thus, the Fibonacci charge pump 146 illustrated in FIG. 4 has a digitally configurable number of stages. This configurability is obtained with the inclusion of transfer switches S4, S8, S12, S16, S20 and S24. Depending on the number of desired stages, only one of these transfer switches is active, i.e., (“switched”—closed and opened over and over) during operation to transfer charge to the output. The switches corresponding to the unused capacitors are likewise disabled.

Table 1 below demonstrates the theoretical input resistance of the charge pump and the output current of the Fibonacci charge pump 146 as functions of the output voltage and the rectified voltage. The output voltage is a fixed voltage, pinned by the LDO sourcing current to the load. For a given number of enabled stages of the charge pump, this leaves the rectified voltage as the sole parameter in determining the input resistance of the charge pump. The rectified voltage, as seen in FIG. 3, is dependent on the values of the charge pump input resistance and the rectenna Thevenin equivalent. At a given number of enabled stages in the charge pump and a given rectified voltage, the expected output current from the charge pump is also included. Again, this must be lower than the current consumed by the load in order for the LDO to source a positive current to regulate the output voltage, a current value that is specific to the LDO being used.

TABLE 1
Theoretical output current and input resistance of a
Fibonacci charge pump for various numbers of enabled stages
TABLE I
Ideal Characteristics of Fibonacci CP

| Stages | Iₒ | Rᵢₙ |
|---|---|---|
| 1 | Cf(2V_{rec} − Vₒ) | $\frac{1}{4 Cf} \cdot \frac{2 {V}_{rec}}{2 {V}_{rec} - {V}_{o}}$ |
| 2 | $\frac{Cf}{2} ( 3 {V}_{rec} - {V}_{o} )$ | $\frac{2}{9 Cf} \cdot \frac{3 {V}_{rec}}{3 {V}_{rec} - {V}_{o}}$ |
| 3 | $\frac{Cf}{6} ( 5 {V}_{rec} - {V}_{o} )$ | $\frac{6}{25 Cf} \cdot \frac{5 {V}_{rec}}{5 {V}_{rec} - {V}_{o}}$ |
| 4 | $\frac{Cf}{15} ( 8 {V}_{rec} - {V}_{o} )$ | $\frac{15}{64 Cf} \cdot \frac{8 {V}_{rec}}{8 {V}_{rec} - {V}_{o}}$ |
| 5 | $\frac{Cf}{40} ( 13 {V}_{rec} - {V}_{o} )$ | $\frac{40}{169 Cf} \cdot \frac{13 {V}_{rec}}{13 {V}_{rec} - {V}_{o}}$ |
| 6 | $\frac{Cf}{104} ( 21 {V}_{rec} - {V}_{o} )$ | $\frac{104}{441 Cf} \cdot \frac{21 {V}_{rec}}{21 {V}_{rec} - {V}_{o}}$ |

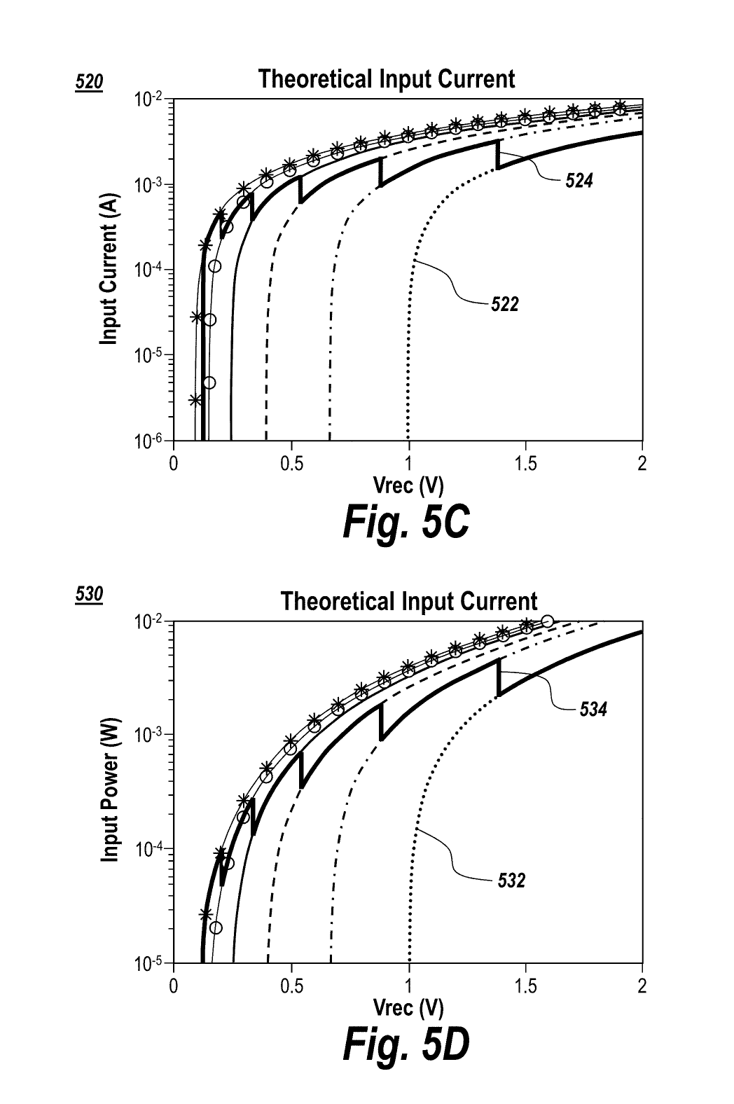

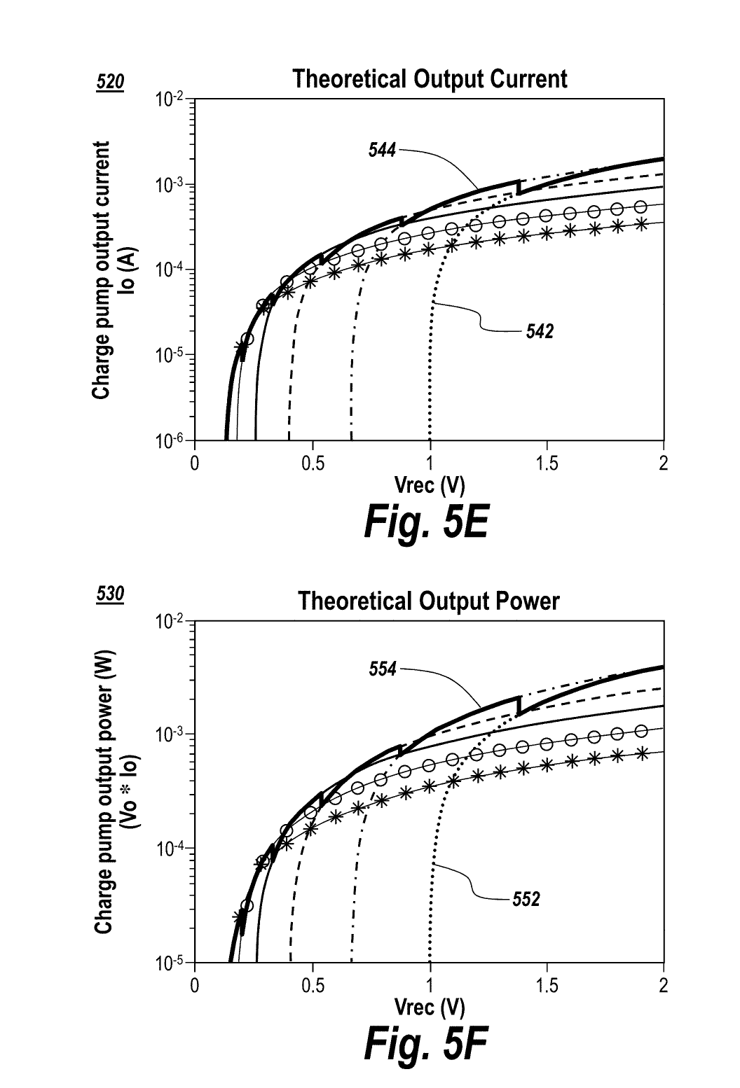

To illustrate the theoretical behaviors of the charge pump, FIGS. 5A-5F show various characteristics of the Fibonacci charge pump 146 with the output voltage Vo fixed at 2.0 V and a fixed Cf (C*f) value for one through six stages plotted as a function of Vrec. As previously mentioned, C is the capacitance of the switching capacitors that make up the charge pump, and f is the frequency at which the switches in the circuit are opened and closed. The various graphs seen in FIGS. 5A-5F are for C=10 nF and f=100 kHz.

FIG. 5A presents a collection of plots 500 corresponding to characteristic curves for the input resistance Rin of the charge pump 146 as a function of Vrec for various numbers of enabled stages. It shows that for each number of stages enabled, the input resistance Rin will vary dramatically over a measured range of rectified voltages. Thus, in the case where there is just one enabled stage, the input resistance characteristic curve 502 is seen to vary from 500 Ohm to 2 kOhm in the plotted range, but in fact will continue to infinity at Vrec=1 V.

In order to remain approximately impedance-matched to the Thevenin equivalent of the rectenna, the range of the input resistance of the charge pump 146 should be minimized. The input resistance system curve 504 for a variable number of stages is also shown in FIG. 5A. The saw tooth-shaped system curve 504 illustrates how the system will modulate the number of enabled stages in the charge pump simply as a function of the measured rectified voltage. The discontinuities or jumps in the input resistance system curve 504 correspond to a set of “threshold voltages.” When the controller senses Vrec has crossed one of the threshold voltages, it updates the number of enabled charge pump stages such that the input impedance is maintained within the bounds of the input resistance system curve 504. In this, the input resistance range is approximately 450 Ohm to 900 Ohm and the average input resistance is 597 Ohm over the expected input rectified voltage range of 0.2 V to 2.0 V. This is a much tighter range than with the characteristic curve 502 corresponding to one enabled stage.

FIG. 5B presents a collection of plots 510 corresponding to characteristic curves for the charge pump efficiency. It shows that the charge pump efficiency hovers around 50% to 70% for Vrec voltages above 0.4 V. Below this range, parasitic capacitances dominate and the efficiency falls. In FIG. 5B, the characteristic curve for just one enabled stage is indicated by 512 and the system curve is indicated by 514.

FIG. 5C presents a collection of plots 520 corresponding to characteristic curves for the input current. In FIG. 5C, the characteristic curve for just one enabled stage is indicated by 522 and the system curve is indicated by 524.

FIG. 5D presents a collection of plots 530 corresponding to characteristic curves for the input power. In FIG. 5D, the characteristic curve for just one enabled stage is indicated by 532 and the system curve is indicated by 534.

FIG. 5E presents a collection of plots 540 corresponding to characteristic curves for the charge pump output current Io. It illustrates the well-defined output current from the charge pump 146, which must be less than the current consumed by the load 150 so the LDO 124 can source current according to its own specifications. In FIG. 5E, the characteristic curve for just one enabled stage is indicated by 542 and the system curve is indicated by 544.

FIG. 5F presents a graph 550 showing characteristic curves for the charge pump output power. It shows that the output power from the charge pump 146 is simply a scaled version of the output current Io (see FIG. 5E) as the output voltage Vo is locked by the LDO 124. The characteristics are therefore very well defined given the system architecture. In FIG. 5B, the characteristic curve for just one enabled stage is indicated by 552 and the system curve is indicated by 554.

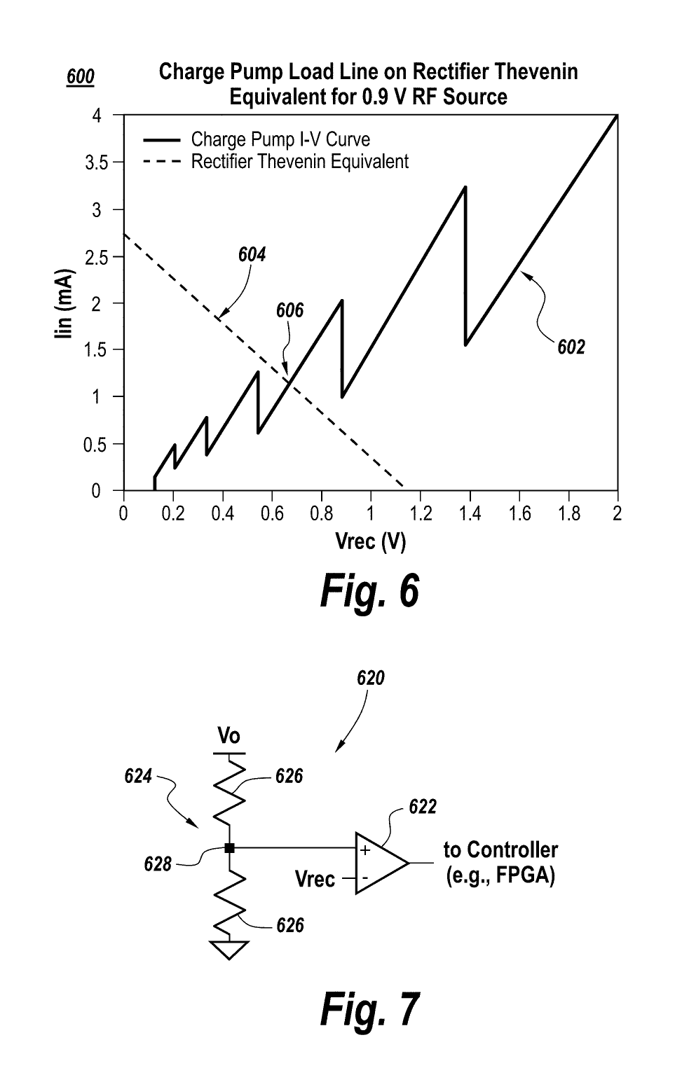

FIG. 6 presents a graph 600 showing the saw tooth-shaped Current-Voltage (IV) function 602 of the charge pump input resistance Rin plotted against the IV function 604 of the Thevenin equivalent of the rectenna.

For a given rectenna, the operating point and input current into the charge pump from the rectenna can be easily predicted. In FIG. 6, the saw tooth-shaped input IV function 602 of the charge pump 146 corresponds to the system curve 524 of FIG. 5C, but on a different scale. By plotting the IV function of the rectenna on top of this, the operating conditions can be determined as the intersection 606 of these curves 602, 604. In FIG. 6, curve 602 represents the same operating conditions described before where C is 10 nF and f is 100 kHz and with the same thresholds, while curve 604 represents the Thevenin equivalent of a specific rectenna at a specific power level determined experimentally. The intersection 606 of the two curves 602, 604 represents a steady-state operating point of 0.673 V for the rectified voltage within the RF harvester.

A low-power controller is used to switch between the number of enabled stages of the charge pump 146, in accordance with the system curve 504 of FIG. 5A. Switching is performed in response to the rectifier's output voltage Vrec which, as mentioned above, can be quantized.

FIG. 7 shows one of six exemplary comparator circuits 620 that can be used to quantize the rectifier output voltage Vrec to help encode the number of charge pump stages T1-T6 to be enabled, at any given time. Each comparator circuit 620 includes a comparator 622 and a voltage divider 624 comprising a pair of resistors separated by a threshold node 628 between the clamped output voltage Vo and, e.g., ground. Since the output voltage Vo is locked by the LDO 124, the threshold voltage at threshold node 628 is constant. The comparator circuit 620 determines whether the rectified output voltage Vrec is greater than a specific threshold, by inputting Vrec and the threshold voltage at threshold node 628 to the comparator 622.

In the case of the charge pump 146 see in FIG. 4, and as also seen from the system curve 524 of FIG. 5B, there are six threshold levels (indicated by sharp jumps forming the “saw teeth” in the system curve 524). This means that there would need to be six of these comparator circuits 620 in this embodiment. The outputs of all six comparators are sent to a system controller. In one embodiment, an FPGA was used for the system controller, but any sort of system controller able to implement a look-up table would work.

The above description of the quantization of Vrec entailed the use of six comparator circuits 620 of the sort seen in FIG. 7. It is understood however, that instead of six different voltage dividers, it may be possible to use a single voltage divider tree comprising seven resistors connected in series between output voltage Vo and ground, with voltage nodes between each pair of adjacent resistors forming the threshold taps.

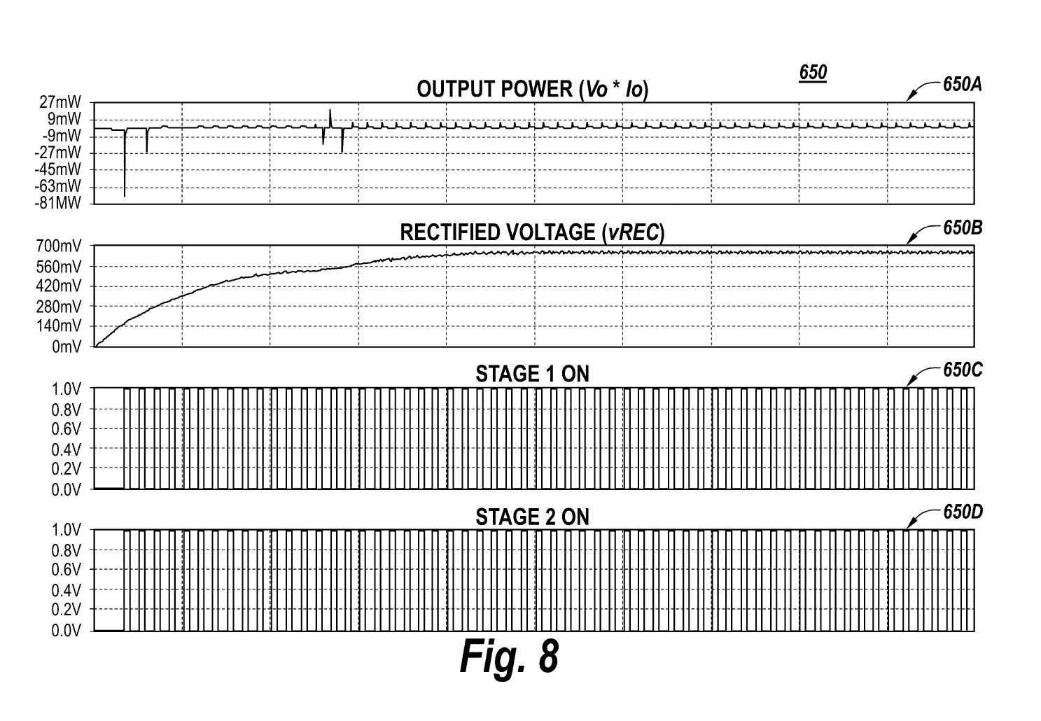

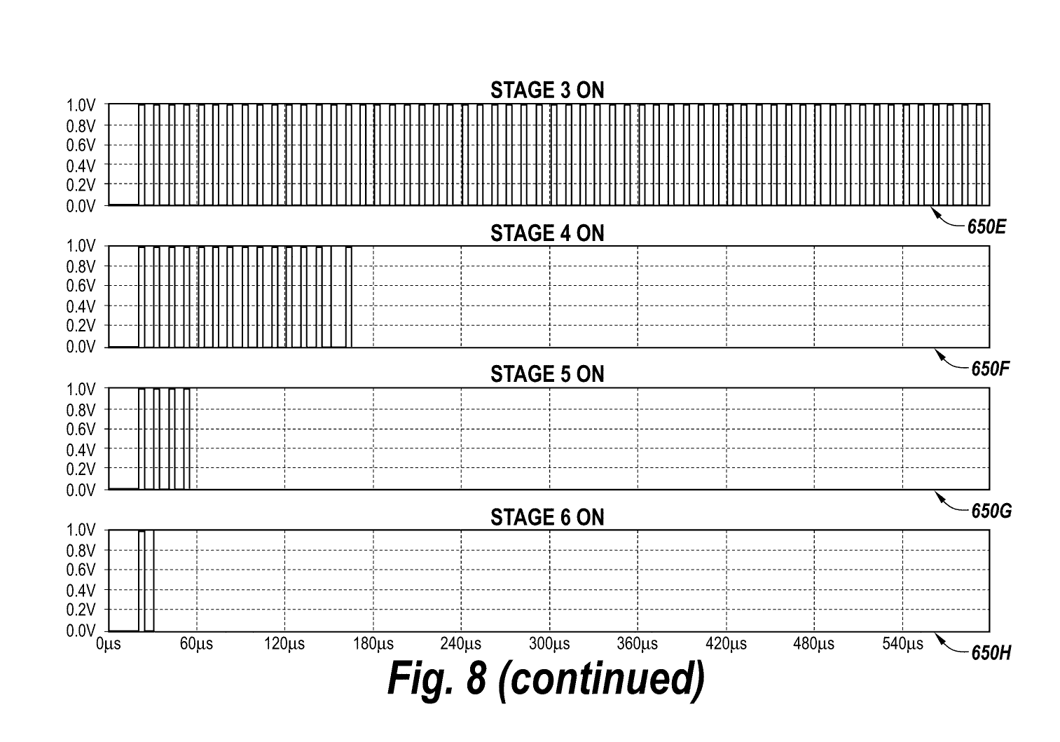

FIG. 8 illustrates simulation results 650 of system controller controlling a charge pump. After designing the input voltage thresholds, the system controller was simulated using logic statements in SPICE. Comparators implemented using the comparator circuit 620 of FIG. 7 were sampled every 3 μs, in order to avoid possible instability caused by transients from switching to a different number of enabled charge pump stages. In the actual FPGA implementation, the comparators 622 were sampled every 1 ms. The rectenna and charge pump values simulated correspond to those in FIG. 6.

In FIG. 8, the simulation results 650 are presented for the output power (650A), rectified voltage (650B), “Stage 1 On” (650C), “Stage 2 On” (650D), “Stage 3 On” (650E), “Stage 4 On” (650F), “Stage 5 On” (650G) and “Stage 6 On” (650H). Oscillations in the plots labeled “Stage 1 On”, “Stage 2 On”, etc. mean that the first, second, etc. (charge pump) switching capacitors, respectively, are operating in the current state of the charge pump. Therefore, “Stage 1 On” through “Stage 5 On” showing square wave oscillations indicates that 5 stages are enabled in the charge pump, since the first 5 capacitors are used in this state. These curves are oscillating digital signals because the capacitors operate by being switched between two configurations (referred to as “Phase 1” and “Phase 2” further below) to supply current to the load.

The FIG. 8 simulation shows the system starting from turn-on. In other words, the rectified voltage begins from 0 V. It can be seen that when the rectified voltage exceeds the lowest of the six thresholds of the comparators, the system controller sets the system to six enabled stages in the charge pump. Then, after the rectified voltage exceeds the second comparator threshold, the system controller sets the system to five enabled stages. The system continued in this transient state until the controller set the system to three enabled stages of the charge pump. Specifically, at simulation time of approximately 160 μs, Vrec passes through 0.5 V, and the controller switches from 4 to 3 stages as illustrated in the system curve of (10). In this setting, the rectified voltage reached its steady-state behavior.

FIG. 6 predicts, at intersection point 606, an operating steady-state rectified voltage of 0.673 V, which would produce 454.3 μW of output power to the 2.0-V load. When the system controller is simulated in SPICE, at steady-state, the RF harvester operated at an average rectified input voltage of 0.671 V and an average output power of 453.6 μW to the load 150. The very close match between calculation and simulation indicates an RF harvester operating at the expected conditions.

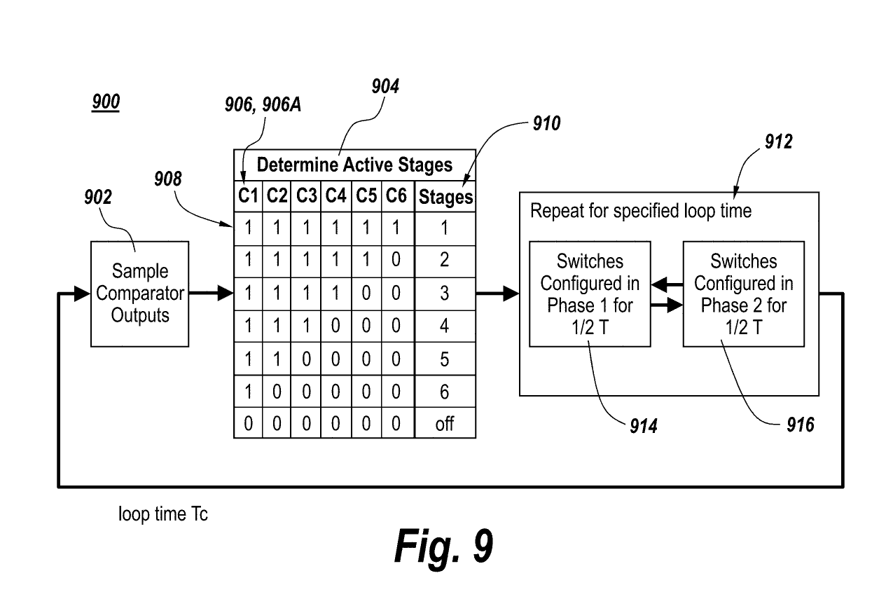

FIG. 9 presents a block diagram 900 to illustrate the system controller's charge pump logic. The logic includes a sampling block 902 configured to sample a plurality (six in the exemplary embodiment) of comparators 622 of the sort seen FIG. 7. The digital output values of the plurality of comparators 622 are input to a look-up table 904 to determine the number of charge pump stages which are to be enabled (“active”). Each column 906 of the look-up table 904 corresponds to a comparator threshold value. Comparator value “C1” (and thus the first column 906A) corresponds to the lowest threshold voltage, comparator value “C2” corresponds to the second lowest threshold voltage, etc., and comparator value “C6” in this case corresponds to the highest threshold voltage. The is appearing in the rows correspond to the logical outputs of the comparators. A larger number of comparator outputs being a logical “1” reflects a higher value of Vrec, and consequently fewer charge pump stages need to be active, as indicated in column 910.

As can be seen in the look-up table 904, if Vrec is higher than the highest threshold (i.e., higher than comparator value “C6”), then only one stage (the first stage) of the charge pump needs to be active. On the other hand, if Vrec is smaller than even the lowest threshold (i.e., lower than comparator value “C1”), the charge pump is turned off

As mentioned above, the charge pump 146 operates in one of a plurality of operational states at any given time and the system controller is configured to determine in which operational state the change pump 146 operates, based on Vrec and without reference to the output voltage of the charge pump 146. (In this context, using the clamping voltage Vo as the supply voltage to the voltage divider 624 does not count as the system controller referring to the output voltage of the charge pump). Indeed, in some embodiments, the charge pump's output voltage is not provided to the system controller at all.

In this exemplary embodiment, each operational state corresponds to the number of stages that are active, and the “stages” column 910 of the look-up table stores information as to how many charge pump stages T1, T2, etc. are to be made active for a given number of comparator outputs indicating that the threshold has been met by Vrec.

In each operational state (i.e., for each number of enabled stages T1, T2, etc.), the charge pump cycles through two phases—referred to herein as “Phase 1” and “Phase 2”—to perform the charge pumping operation. After the number of active stages is determined based on the outputs of the comparators 622 and the look-up table 904, a system controller cycling block 912 cycles the charge pump between the Phase 1 and Phase 2 switch settings, for a predetermined loop time Tc. During the predetermined loop time Tc, the cycling logic 912 alternatingly sets a first subset of the switches S1 through S24 to the Phase 1 settings for ½T using cycling logic sub-block 914 (i.e., for the first half the Phase 1+Phase 2 cycle period T), and then sets a second subset of the switches S1 through S24 to the Phase 2 settings for ½T using cycling logic sub-block 916 (i.e., for the second half of the Phase 1+Phase 2 cycle period T).

After the charge pump 164 has looped for the specified (predetermined) loop time Tc, the system controller resamples the comparator outputs 622 and begins the process again. How long the controller continues to cycle the charge pump between Phase 1 and Phase 2 before resampling the comparators can depend on comparator characteristics. For instance, if high-speed, high-power dynamic comparators are employed, the loop time might be chosen to be large (e.g. 1 ms) to minimize power consumption by the comparators. On the other hand, if the low-power comparators are employed, the loop time might be chosen to be smaller (e.g. 100 microseconds) and thus the comparators are sampled more often. Other factors may also influence the loop time Tc for which the charge pump is cycled between resampling of the comparators.

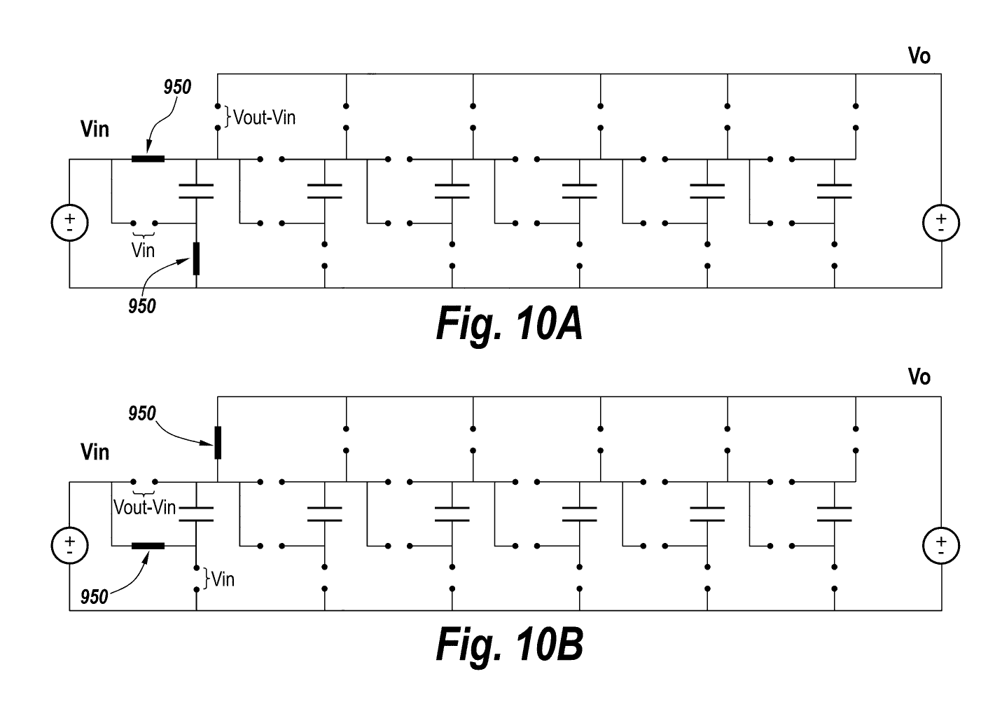

FIGS. 10A and 10B show the positions (open or closed) of the charge pump's switches in Phase 1 and Phase 2, respectively, for the operational state in which only the first stage T1 is active. In FIGS. 10A and 10B, the “closed” position of a charge pump's switch is indicated by a thickened line 950 bridging the switch contacts. The system controller includes a clock, e.g., a counter, to ensure that the switches of the charge pump remain in Phase 1 for one half of the cycle time T (“switching period T”) and in Phase 2 for the other half of the cycle time T. It is understood that T is equal to 1/f , where f is the operating switching frequency.

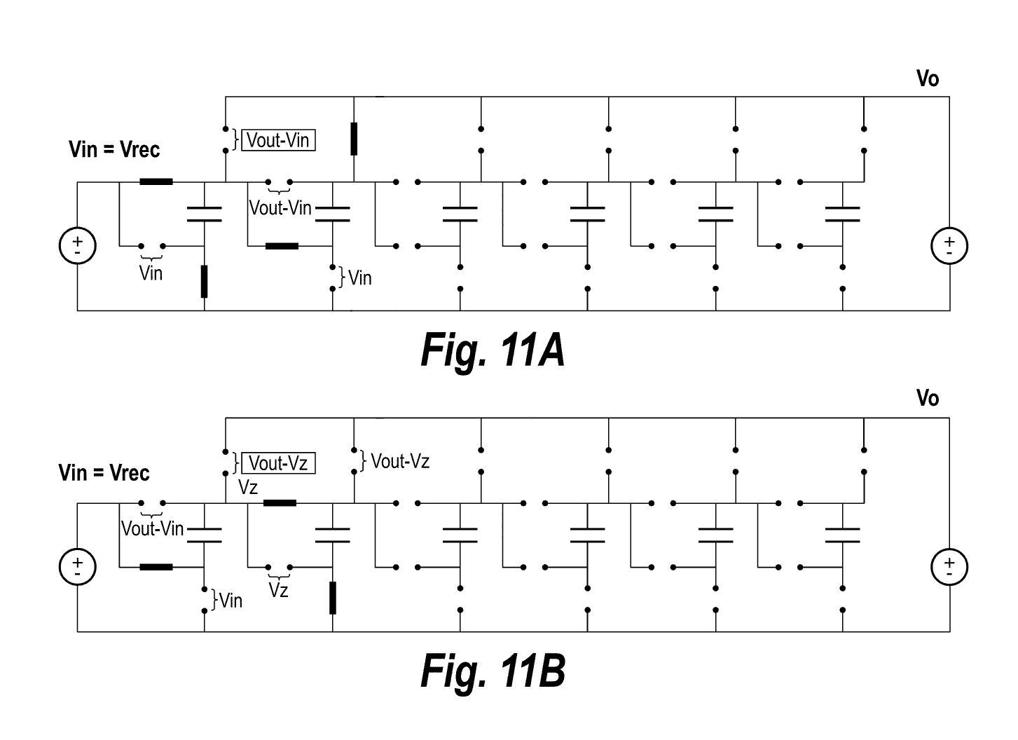

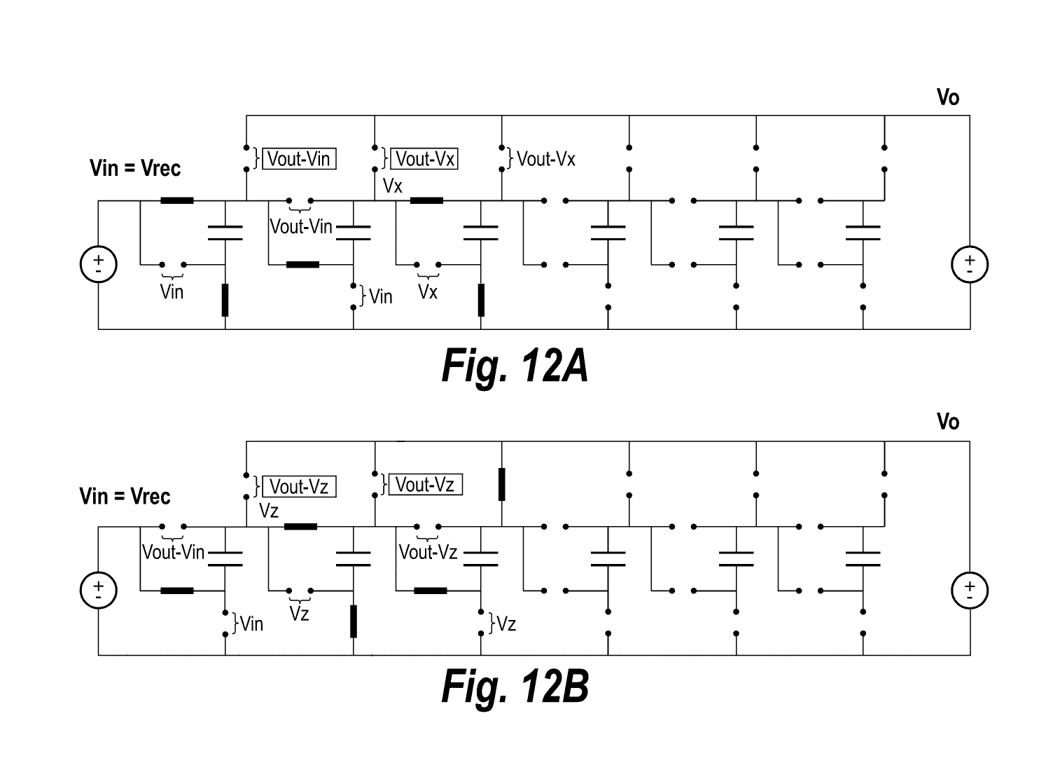

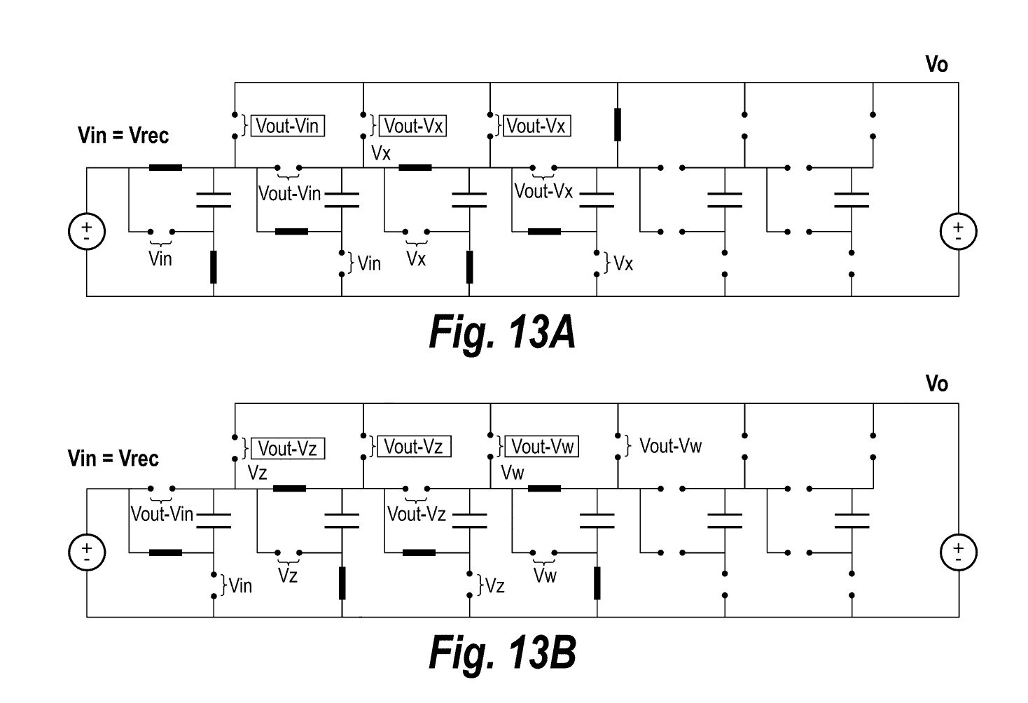

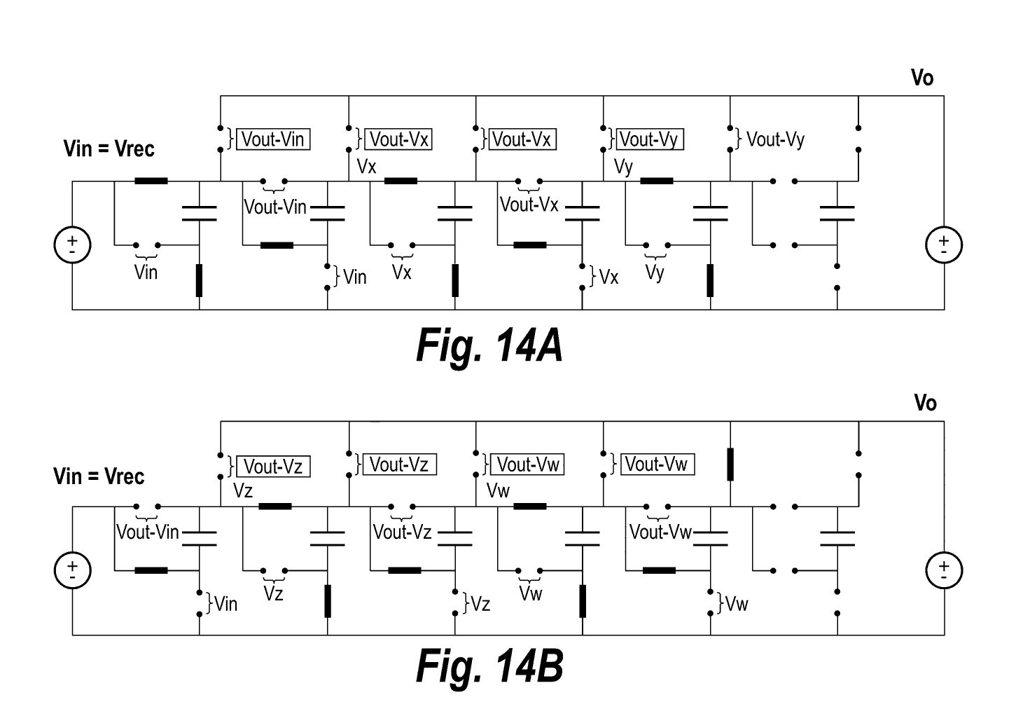

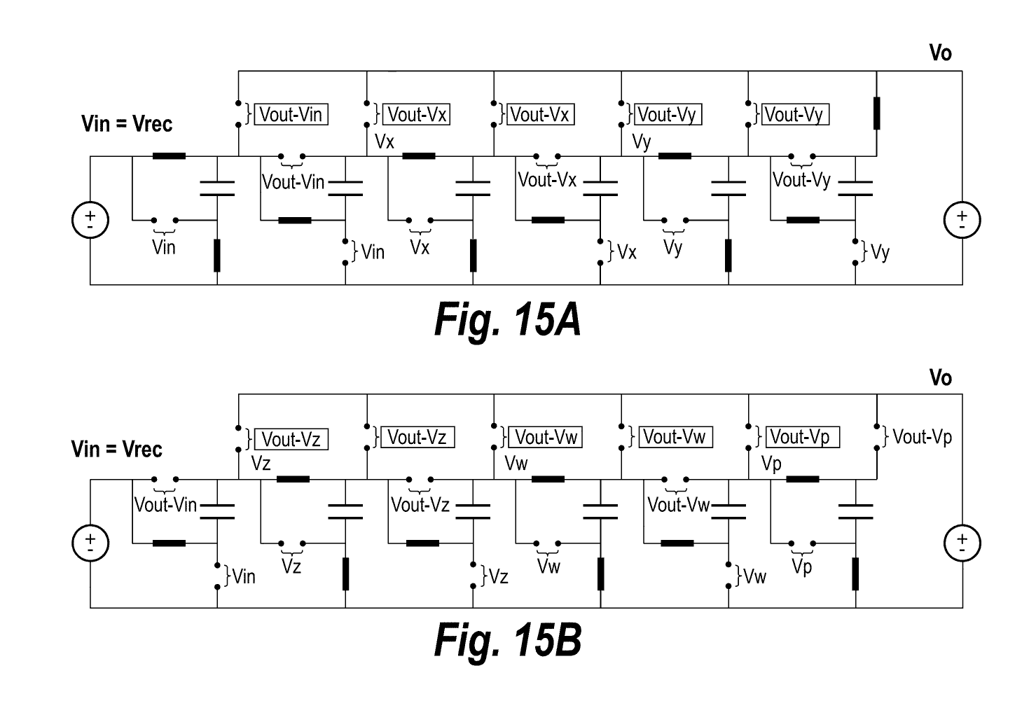

FIGS. 11A and 11B show the positions (open or closed) of the charge pump's switches for when two stages are enabled. FIGS. 12A and 12B show the positions (open or closed) of the charge pump's switches for when three stages are enabled. FIGS. 13A and 13B show the positions (open or closed) of the charge pump's switches for when four are enabled. FIGS. 14A and 14B show the positions (open or closed) of the charge pump's switches for when five stages are enabled. Finally, FIGS. 15A and 15B show the positions (open or closed) of the charge pump's switches for when all six stages are enabled.

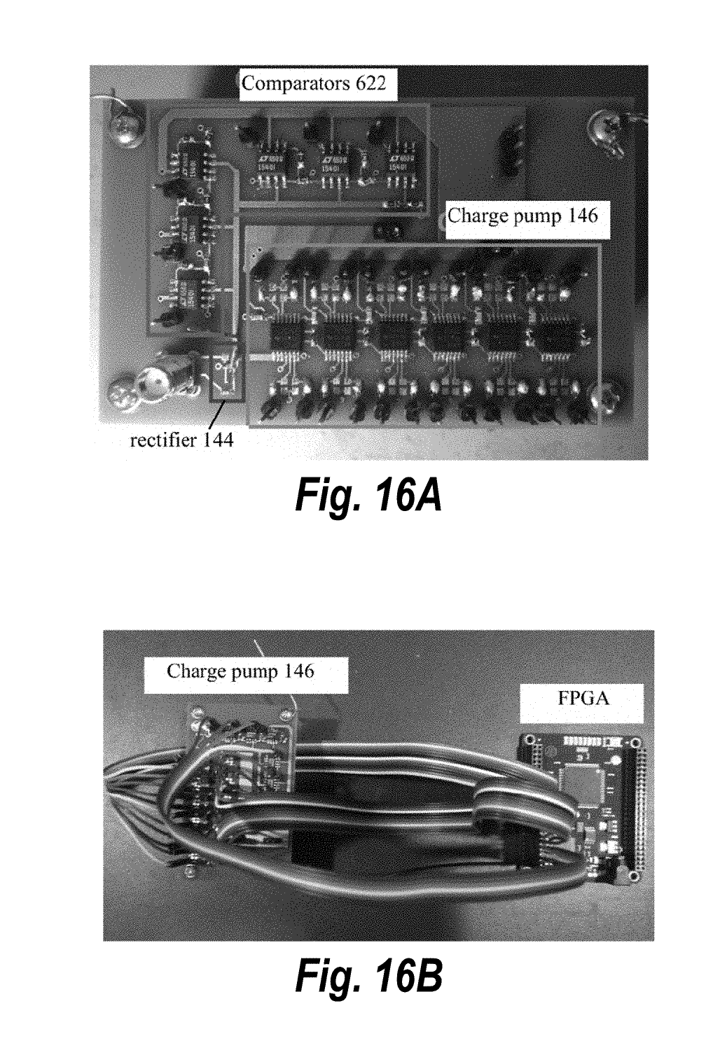

After having the charge pump designed around the RF rectifier and its expected input voltages and after simulating the system and its controller, the entire multi-source power supply 100 was physically tested with various input powers. The built rectifier 144, charge pump 146, and comparators 622 are shown in FIG. 16A, and the complete RF harvester with an interface to the digital controller prototyped using an FPGA is shown in FIG. 16B.

The charge pump 146 may be configured as a fully integrated device, such as an ASIC or the like. The rectifier 144 is much harder to integrate because high performance Schottky diodes are not available in most ASIC processes. However, implementing the rectifier as a fully integrated device is also contemplated. In such case, the entire system minus the antenna may be integrated into a single device. The system also obviates the need for an impedance-matching network, which almost always comprises discrete components. The system allows low-power harvested RF energy to still be use for high-load applications for multi-source harvesting or for increasing battery life in battery-powered systems.

Also, while the present RF harvester was designed for a given antenna with a given impedance, incorporating the antenna impedance into the analysis as a tunable parameter is also contemplated.

Additionally, while the present embodiment includes a switched-capacitor charge pump 146, a diode-based charge pump may also be used.

Although the present invention has been described to a certain degree of particularity, it should be understood that various alterations and modifications could be made without departing from the spirit or scope of the invention as hereinafter claimed.

What is claimed is:

1. A multi-source power supply comprising:
a primary power source;
a voltage regulator configured to receive power from the primary power source and, in response thereto, output a predetermined constant DC voltage Vo at a regulator voltage output;
an auxiliary DC power source having an auxiliary direct current (DC) voltage output Vrec; and
a charge pump having the auxiliary DC voltage output Vrec input thereto, and further having a charge pump output; wherein:
the regulator voltage output is connected to the charge pump output such that the charge pump output is clamped at said predetermined constant DC voltage Vo output by the voltage regulator.

2. The multi-source power supply according to claim 1, wherein:
the primary power source is a primary DC power source having a primary voltage output (Vstor); and
the voltage regulator is configured to receive the primary voltage output (Vstor).

3. The multi-source power supply according to claim 2, wherein:
the voltage regulator comprises low drop-out voltage regulator (LDO) having an LDO voltage input, an LDO voltage output, and an LDO dropout voltage; and
the primary voltage output (Vstor) is greater than the LDO voltage output Vo plus the dropout voltage of the LDO.

4. The multi-source power supply according to claim 1, wherein:
the auxiliary DC power source comprises an RF antenna connected to a rectifier configured to output the auxiliary DC voltage output.

5. The multi-source power supply according to claim 1, wherein the charge pump is a switched-capacitor charge pump.

6. The multi-source power supply according to claim 1, wherein the charge pump is a diode-based charge pump.

7. The power supply according to claim 1, further comprising:
a controller configured to control operation of the charge pump;
the charge pump is operable in a plurality of operational states and an output current of the charge pump is a function of the specific state in which the charge pump operates; and
the controller is configured to determine in which state the charge pump operates, in response to the auxiliary DC voltage output (Vrec) and without reference to the output voltage of the charge pump.

8. The power supply according to claim 7, wherein:
the charge pump comprises a plurality of stages;
an operational state of the charge pump is determined by the number of stages that are enabled; and
the controller is configured to determine which stages to enable, in response to the auxiliary DC voltage output (Vrec).

9. The power supply according to claim 8, wherein:
the charge pump is a switched-capacitor charge pump comprising a plurality of switches configured to control current flow through a plurality of capacitors; and
the controller comprises a lookup table storing information reflective of which switches are to be open and which switches are to be closed, the lookup table being indexed in response to a value of the auxiliary DC voltage output (Vrec).

10. The power supply according to claim 9, wherein:
each stage of the charge pump comprises a single capacitor and a plurality of switches which are configured to control transfer of charge to said single capacitor.

11. The power supply according to claim 7, wherein:
in any given operational state, the charge pump cycles between two complementary phases; and
the controller comprises logic configured to determine when to cycle the charge pump between the two complementary phases.

12. The power supply according to claim 7, wherein:
the output voltage of the charge pump is not provided to the controller.

13. The power supply according to claim 7, wherein:
the controller is configured to control the charge pump such that an input impedance of the charge pump is maintained to match a source impedance of the auxiliary DC power source, in each operational state.
